(19) United States
(12) Patent Application Publication
(10) Pub. No.: US 2013/0068906 A1
(43) Pub. Date: Mar. 21, 2013

(54) Fixing Device for Fixing a Baluster to a Handrail

(71) Applicant: Min-Ju Chung, Taichung City (TW)

(72) Inventor: Min-Ju Chung, Taichung City (TW)

(21) Appl. No.: 13/236,010

(22) Filed: Sep. 19, 2011

(51) Int. Cl. F16M 13/02

(52) U.S. Cl. 248/222.14

(57) ABSTRACT

A fixing device for fixing a baluster to a handrail includes a fixing body having an abutment plate adapted to abut against the handrail, and a coupler projecting from the abutment plate. The abutment plate has two fixing holes formed respectively near two opposite sides of the coupler. The fixing device further has a baluster connector having a pivot end connected pivotally to the coupler, and a sleeve end opposite to the pivot end and adapted to extend around the baluster. A locking element is disposed at the sleeve end to secure the baluster connector to the baluster. Two screws are respectively extending through the fixing holes.

### BACKGROUND OF THE INVENTION

1. Field of the Invention

The invention relates to a construction accessory, and more particularly to a fixing device for fixing a baluster to a handrail.

2. Description of the Related Art

Referring to FIGS. 1 and 2, a conventional retractable baluster disclosed in CN2011519868 comprises a baluster body 2, a first sleeve unit 3, a first coupler 4, a second sleeve unit 5 and a second coupler 6. The baluster body 2 has a first end 201 and a second end 202 opposite to the first end 201. The first sleeve unit 3 and the second sleeve unit 5 are slidably telescoped on the first end 201 and the second end 202, respectively. The first sleeve unit 3 and the second sleeve unit 5 have respective tubular members 301, 501 and ring members 302, 502 fixed respectively to the tubular members 301, 501. The first coupler 4 and the second coupler 6 are both screws which are capable of extending through the ring members 302, 502 and threaded in the tubular members 301, 501, so that the tubular members 301, 501 can be fixed respectively to the first and second ends 201, 202. Therefore, by the sliding of the first end 201 and the second end 202 of the baluster body 2 with respect to the respective first sleeve unit 3 and the second sleeve unit 5, the total length of the retractable baluster between a handrail 7 and a floor 8 can be adjusted according the requirements of the construction environment. In addition, the total length of the retractable baluster can be fixed by the first coupler 4 and the second coupler 6 after the adjustment process.

Although such a retractable baluster is easy to construct and safe, an upper mounting hole 701 and a corresponding lower mounting hole 801 must first be drilled respectively in the handrail 7 and the floor 8 before the retractable baluster is mounted. In addition, the tubular members 301, 501 must have glue applied thereto so as to fix respectively to the upper mounting hole 701 and the lower mounting hole 801. When the inclination of the handrail 7 is varied, the mounting of the retractable baluster is difficult if the angle and/or the position of the drilled mounting holes are incorrect.

### SUMMARY OF THE INVENTION

Therefore, a main object of the present invention is to provide a fixing device for fixing a baluster to a handrail, which is simple in structure, easy to install the baluster, and is suitable for balusters with different inclinations.

Accordingly, a fixing device for fixing a baluster comprises: a fixing body having an abutment plate, and a coupler projecting from the abutment plate, the abutment plate having two fixing holes formed respectively near two opposite sides of the coupler; a baluster connector having a pivot end connected pivotally to the coupler, and a sleeve end opposite to the pivot end and adapted to extend around the baluster; a locking element disposed in the sleeve end to secure the baluster connector to the baluster; and two screws respectively extending through the fixing holes.

### BRIEF DESCRIPTION OF THE DRAWINGS

Other features and advantages of the present invention will become apparent in the following detailed description of the preferred embodiment with reference to the accompanying drawings, of which:

FIG. 1 is schematic view illustrating a conventional retractable baluster;

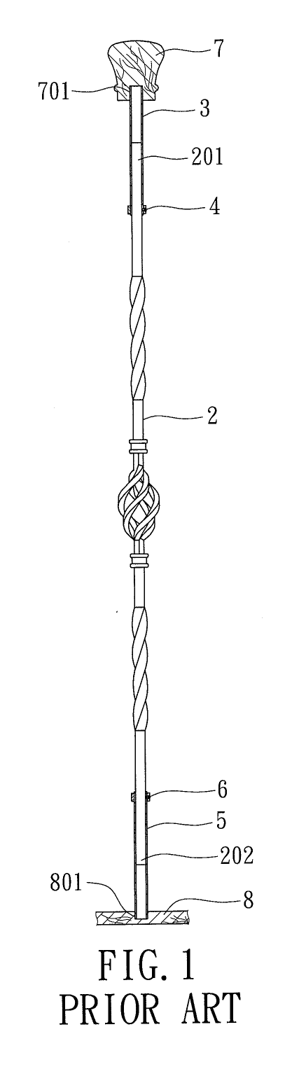

FIG. 2 is a fragmentary exploded perspective view of the conventional retractable baluster in FIG. 1;

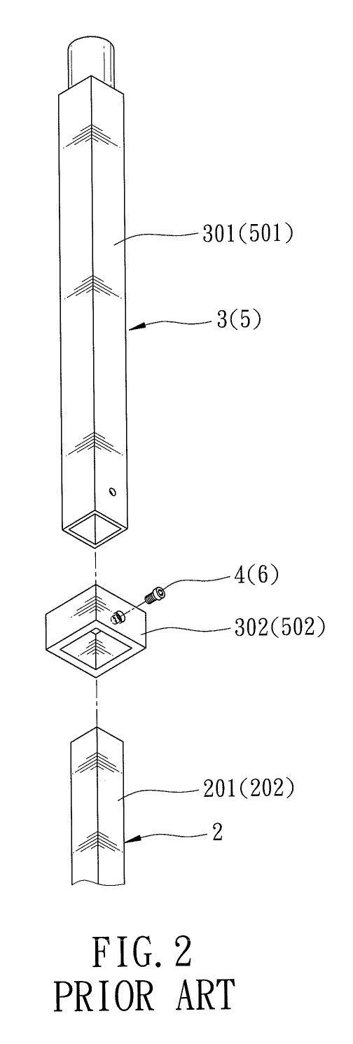

FIG. 3 is a schematic view illustrating a preferred embodiment of a fixing device according to the present invention, which is used to fix a baluster to a handrail;

FIG. 4 is a fragmentary cross sectional view of the preferred embodiment, illustrating that the fixing device is connected between a handrail and a baluster;

FIG. 5 is an exploded perspective view of the preferred embodiment; and

FIG. 6 is a perspective view of the preferred embodiment.

### DETAILED DESCRIPTION OF THE PREFERRED EMBODIMENT

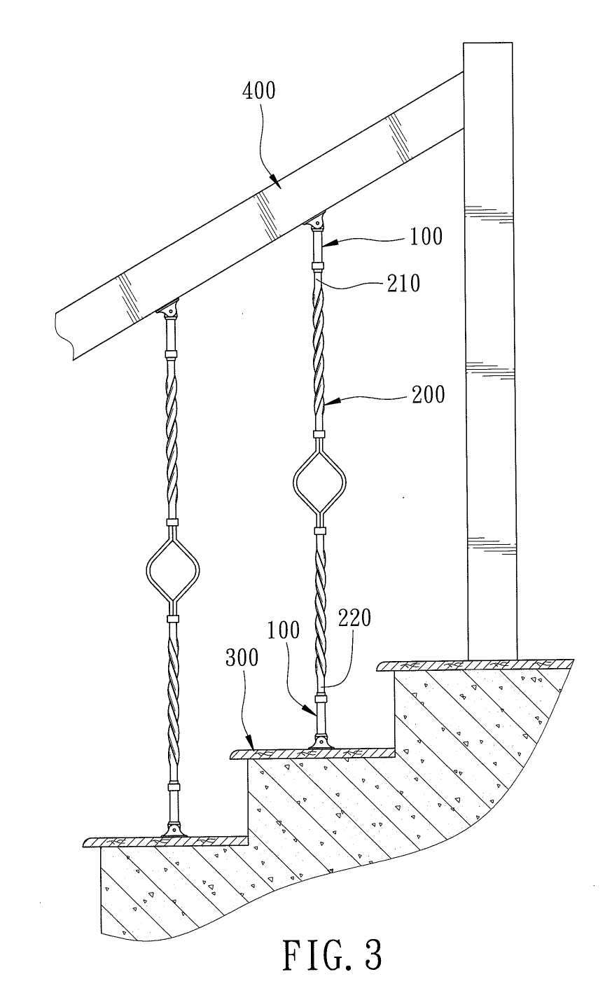

Referring to FIG. 3, a fixing device 100 for fixing a baluster 200 to a handrail 400 according to a preferred embodiment of the present invention is shown. The baluster 200 is mounted between a floor 300 and the handrail 400. The baluster 200 has a first end 210 for connection with the handrail 400 and a second end 220 for connection with the floor 300.

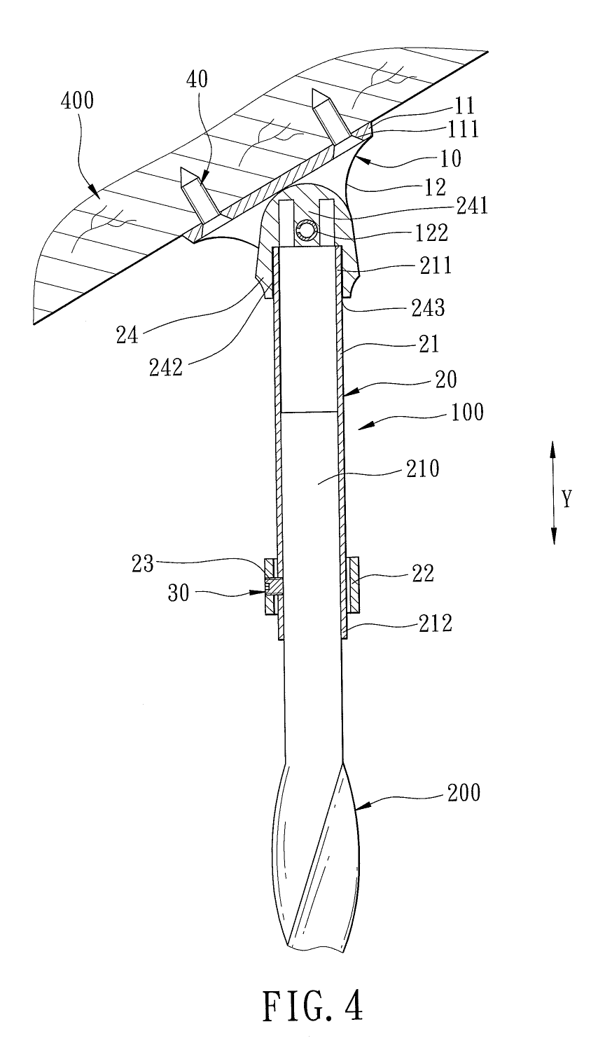

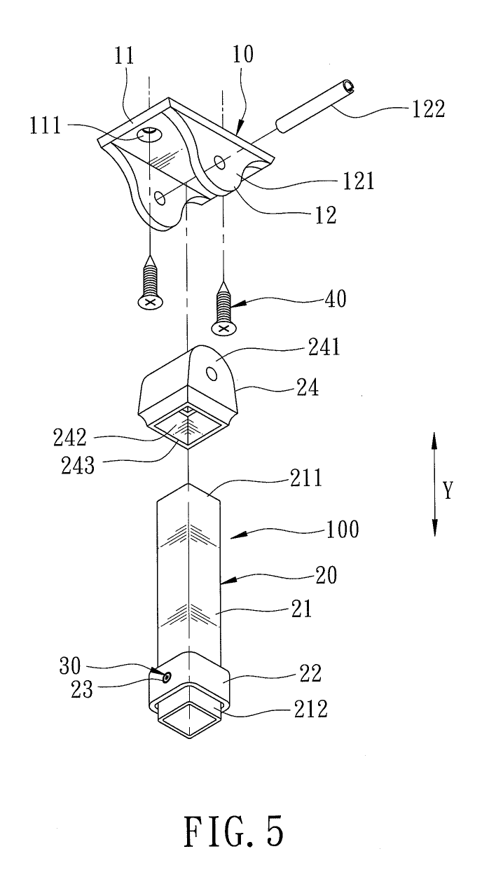

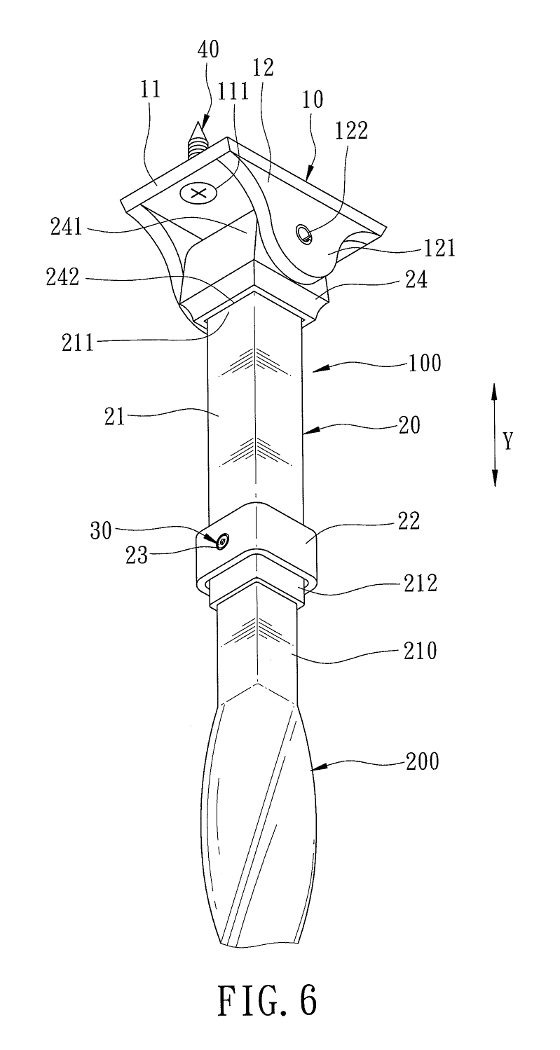

Referring also to FIGS. 4, 5 and 6, the fixing device 100 comprises a fixing body 10, a baluster connector 20 mounted on the fixing device 100 and extending in a longitudinal direction Y, a locking element 30, and two screws 40.

The fixing body 10 has an abutment plate 11 adapted to abut against the handrail 400, and a coupler 12 projecting from the abutment plate 11. The abutment plate 11 has two fixing holes 111 formed respectively near two opposite sides of the coupler 12. The coupler 12 of the fixing body 10 includes two spaced apart pivot plates 121, and a pivot pin 122 extending transversely through the pivot plates 121 in a direction perpendicular to the longitudinal direction.

The baluster connector 20 has a pivot end 241 connected pivotally to the coupler 12, and a sleeve end 212 opposite to the pivot end 241 and adapted to extend around the baluster 200. The baluster connector 20 further has a tubular body 21 extending in the longitudinal direction Y and adapted to be sleeved around the baluster, a ring member 22, a screw hole 23 extending radially through the ring member 22 in the direction perpendicular to the longitudinal direction Y, and a pivot block 24 attached to a connecting end 211 of the tubular body 21 and connected pivotally to the coupler 12. The tubular body 21 has the sleeve end 212. The connecting end 211 is opposite to the sleeve end 212. The ring member 22 is disposed around the sleeve end 212. The connecting end 211 is inserted into the pivot block 24. The pivot block 24 has the pivot end 241 and is connected to the pivot pin 122 between the pivot plates 121. The pivot block 24 further has an insert hole 242 that opens only at one side 243 opposite to the pivot end 241 and that extends in the longitudinal direction Y. The connecting end 211 of the tubular body 21 is inserted into the insert hole 242.

The locking element 30 is disposed at the sleeve end 212 to secure the baluster connector 20 to the baluster 200. More specifically, the locking element 30 is an internally hexagonal countersunk screw and extends through the screw hole 23 and penetrates threadedly the sleeve end 212 for abutting against the baluster 200.

In this embodiment, the screws 40 are self-tapping wood screws and respectively extend through the fixing holes 111 of the fixing body 10 so as to secure the fixing body 10 to the handrail 400.

When the baluster 200 is to be mounted, the first end 210 is first inserted from the sleeve end 212 of the tubular body 21 of the fixing device 100. The baluster 200 and the fixing device 100 are then both disposed between the floor 300 and the handrail 400 and moved along the longitudinal direction Y. Thereafter, the fixing device 100 is pulled upwardly toward the bottom portion of the handrail 400, and the pivot block 24 is pivoted relative to the fixing body 10 to enable the abutment plate 11 to accommodate the inclination angle of the handrail 400 and to abut against the bottom side of the handrail 400. Finally, the fixing body 10 is fixed to the handrail 400 by tightening the screws 40, and the fixing device 100 is fixed to the baluster 200 by tightening the locking element 30, thereby completing the mounting of the baluster 200.

The advantages of the fixing device 100 of the present invention are as follows:

1. Since the fixing device 100 can be connected to the first end 210 of the baluster 200 and the baluster 200 can be mounted stably between the floor 300 and the handrail 400 by means of the fixing device 100, the installation of the baluster 200 is easy.

2. It is not necessary to preform holes in the handrail 400 and to use glue in the holes. The fixing device 100 can be fixed to the handrail 400 by using the screws 40. The operation thereof is simple and fast.

3. By virtue of the pivot action of the pivot block 24 with respect to the fixing body 10, the abutment plate 11 can accommodate the inclination angle of the handrail 400 to abut against the bottom side of the handrail 400. Therefore, by using the fixing device 100, the baluster 200 can be assembled easily with the handrail 400 inclining at different angles.

4. It is worth mentioning that another fixing device 100 may be used between the second end 220 of the baluster 200 and the floor 300, as shown in FIG. 3, to facilitate assembly in case the floor 300 is uneven.

5. It is also worth mentioning that, although both ends of the baluster 200 are retractable due to the use of the two fixing devices 100 at both ends, as shown in FIG. 3, the baluster 200 may be arranged to be retractable only at one end by providing the fixing device 100 at the first end 210 of the baluster 200.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A fixing device for fixing a baluster, comprising:
a fixing body having an abutment plate, and a coupler projecting from said abutment plate, said abutment plate having two fixing holes formed respectively near two opposite sides of said coupler;
a baluster connector having a pivot end connected pivotally to said coupler, and a sleeve end opposite to said pivot end and adapted to extend around the baluster;
a locking element disposed at said sleeve end to secure said baluster connector to the baluster; and
two screws respectively extending through said fixing holes.

2. The fixing device of claim 1, wherein said baluster connector further has a tubular body adapted to be sleeved around the baluster, a ring member, a screw hole extending radially through said ring member, a pivot block attached to a connecting end of said tubular body and connected pivotally to said coupler, said tubular body having said sleeve end, said connecting end being opposite to said sleeve end, said ring member being disposed around said sleeve end, said connecting end being inserted into said pivot block, said locking element extending through said screw hole and penetrating threadedly said sleeve end for abutting against the baluster.

3. The fixing device of claim 2, wherein said coupler of said fixing body includes two spaced apart pivot plates, and a pivot pin extending transversely through said pivot plates, said pivot block having said pivot end and being connected to said pivot pin between said pivot plates, said pivot block further having an insert hole that opens only at one side opposite to said pivot end, said connecting end of said tubular body being inserted into said insert hole.

4. The fixing device of claim 1, wherein said screws are self-tapping wood screws.
